(19) United States
(12) Patent Application Publication
(10) Pub. No.: US 2019/0019227 A1
(43) Pub. Date: Jan. 17, 2019

(54) SYSTEM AND METHOD FOR STREAMLINING ACCESS TO DEVICE INFORMATION

(71) Applicant: Harold T. Fogg, Aurora, CO (US)

(72) Inventor: Harold T. Fogg, Aurora, CO (US)

(21) Appl. No.: 16/029,561

(22) Filed: Jul. 7, 2018

Related U.S. Application Data
(60) Provisional application No. 62/530,947, filed on Jul. 11, 2017.

(51) Int. Cl. G06Q 30/02

(52) U.S. Cl. CPC G06Q 30/0281

(57) ABSTRACT

A method is provided for providing access to information about a product. An identifier identifying a single unit of a product is received from a user, the identifier identifying a single unit of a product and comprising a serial number of the unit, a labeler code identifying a manufacturer of the unit, and a product application code. If the identifier is invalid, the identifier is rejected and an error message is sent to the user. If the identifier is valid, the identifier is parsed into a serial number, a product application code, and a labeler code. If the serial number does not match the product application code, the identifier is rejected and an error message is sent to the user. If the serial number matches the product application code, access to information is sent to the user identifying the manufacturer and the product and information pertaining to the specific unit.

### RELATED APPLICATION DATA

The present application is related to and claims the benefit of commonly-owned and co-pending U.S. Provisional Application Ser. No. 62/530,947 entitled SYSTEM AND METHOD FOR STREAMLINING ACCESS TO DEVICE INFORMATION, filed on Jul. 11, 2017, which application is incorporated herein by reference in its entirety. The present application is also related to commonly-owned U.S. Pat. No. 9,489,345 entitled SYSTEM AND METHOD FOR PROVIDING PRODUCTS AND LOCATIONS, issued on Nov. 8, 2018, which patent is incorporated herein by reference in its entirety.

TECHNICAL FIELD

### The present invention relates generally to the unique device identification (“UDI”) system and, in particular, to a system and method for streamlining access to device information.

### BACKGROUND ART

The U.S. Food and Drug Administration (“FDA”) established a system to identify and track medical devices at any stage of their distribution, sale, and use. Manufacturers (“labelers”) acquire a unique device identifier (“UDI”) for each device and provide a label for each device, the label including the UDI. Information about each device, including its UDI, is also entered into an FDA database, the Global Unique Device Identification Database (“GUDID”). The GUDID is publically accessible, allowing anyone to find information about a device. In this way, events pertaining to a device may be reported and analyzed and affected devices may be tracked, located and, if necessary, recalled.

As the system is initially designed, labelers purchase from a third party a UDI for each device and enter information related to the associated device stored in the GUDID. However, a “device” may be manufactured in many different variations. For example, while contact lenses are “devices,” they are made in a large number of prescriptions and a variety of curvatures to fit the shape of the eyes of different patients. Thus, each lens of a particular combination of prescription and shape should have a unique identifier, resulting in an unwieldy and expensive number of identifiers.

As another example, medical monitors, such as pressure monitors, require cabling with which sensors are connected to the monitor. Each cable has a connector at the sensor end and another at the monitor end. Different sensors may require different connectors and different sensor manufactures may use different connectors. Similarly, different monitors may use different connectors and different monitor manufactures may use different connectors and different wiring. Further, cables are needed in different lengths. Thus, there are tens of thousands of possible unique combinations of sensor connector, monitor connector, wiring requirements, and cable length, each combination being a separate “device” requiring its own UDI. Again, the result is an unwieldy and expensive number of identifiers but the number of units of each of the combinations may be relatively low.

### SUMMARY OF THE INVENTION

Embodiments of the present invention provide a method for providing access to information about a product. The method comprises receiving from a user an identifier identifying a single unit of a product. The identifier comprises a serial number of the unit, a labeler code identifying a manufacturer of the unit, and a product application code identifying a specific application for the unit. A determination is made as to whether the identifier is a valid identifier. If the identifier is invalid, the identifier is rejected and an error message is sent to the user. If the identifier is valid, the identifier is parsed into a serial number, a product application code, and a labeler code. A determination is made as to whether the serial number matches the product application code. If the serial number does not match the product application code, the identifier is rejected and an error message is sent to the user. If the serial number matches the product application code, access to information is sent to the user identifying the manufacturer of the product and information pertaining to the specific unit.

Embodiments of the invention also provide a system for providing access to information about a product. The system comprises an input module configured to receive from a user an identifier identifying a single unit of a unit. The identifier comprises a serial number of the unit, a labeler code identifying a manufacturer of the unit, and a product application code identifying a specific application for the device model. A first validation module is configured to determine if the identifier is a valid identifier and to reject the identifier and send an error message to the user if the identifier is not valid. A parsing module is configured to parse a valid identifier into a serial number, a product application code, and a labeler code. A second validation module is configured to determine if the serial number matches the product application code and to reject the identifier and send an error message to the user if the serial number does not match the product application code. An output module is configured to provide to the user access to information identifying the manufacturer of the product and information pertaining to the specific unit.

### BRIEF DESCRIPTION OF THE DRAWINGS

FIG. 1 is a system flow diagram of an embodiment of a system for streamlining access to device information;

FIG. 2 is a system flow diagram of a second embodiment of a system for streamlining access to device information;

FIG. 3 is a system flow diagram of a third embodiment of a system for streamlining access to device information; and

FIG. 4 is a flowchart of an embodiment of a method implemented by the embodiments illustrated in FIGS. 1-3.

### DETAILED DESCRIPTION OF THE PREFERRED EMBODIMENT

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components and so forth. In other instances, well-known structures, materials, or operations are not shown or described in detail to avoid obscuring aspects of the invention.

Embodiments of the present invention provide a system and method for streamlining access to device information based on a product identifier. The identifier comprises a product code including a serial number, unique to each individual unit of a product or device, and a labeler code, identifying the manufacturer of the unit. The product identifier may also include a product application code, identifying a specific application for the product. As used herein, the term “unit” refers to one of a number of devices of the same model.

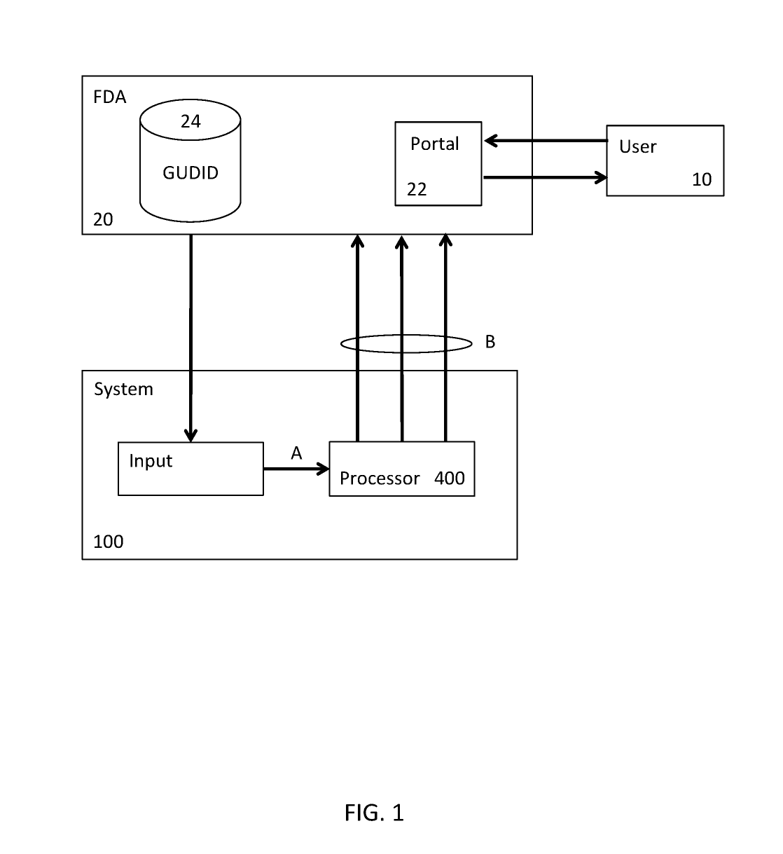

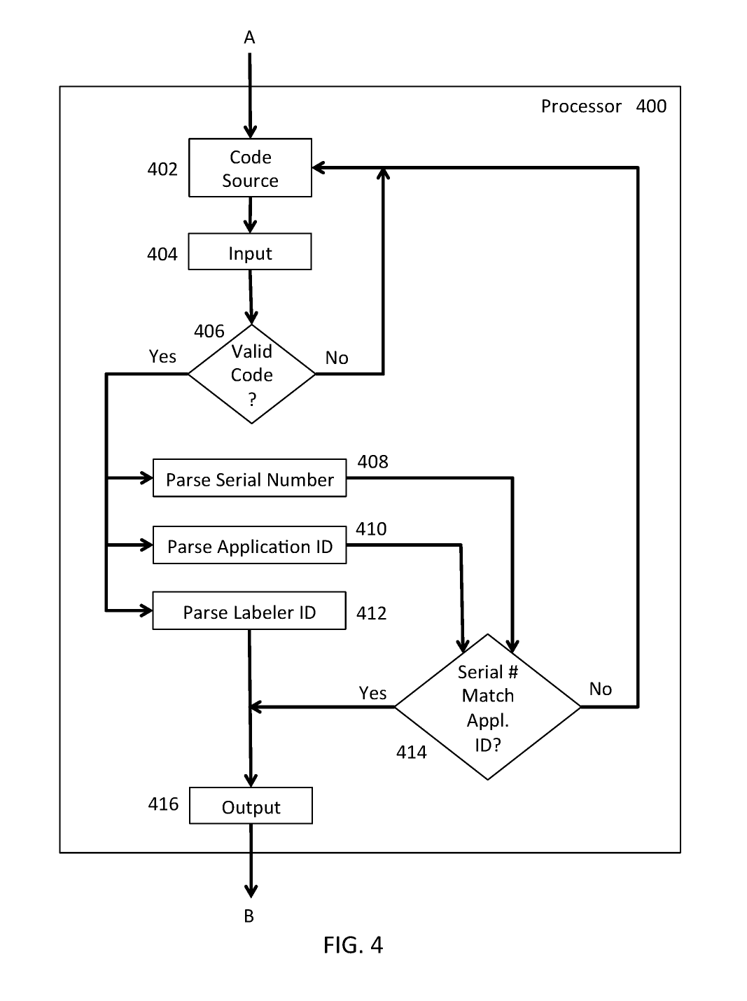

FIG. 1 illustrates a first embodiment of a system employing the method of the present invention. A user 10 making an inquiry accesses the FDA website 20 through a portal 22 and enters a product code or identifier. The FDA website 20, coupled to a system 100 such as through the internet, passes the product code to the system 100 where it is processed by processor 400 (as detailed in the flowchart of FIG. 4). The product code is used to obtain a link to product information on the manufacturer's website and passed to the user through the FDA website portal 22. The user 10 may then use the link to access information about the product in general and the specific unit in particular. Alternatively, the system 100 may directly cause the manufacturer's website to open in the user's browser. Information may also be obtained from the GUDID database 24.

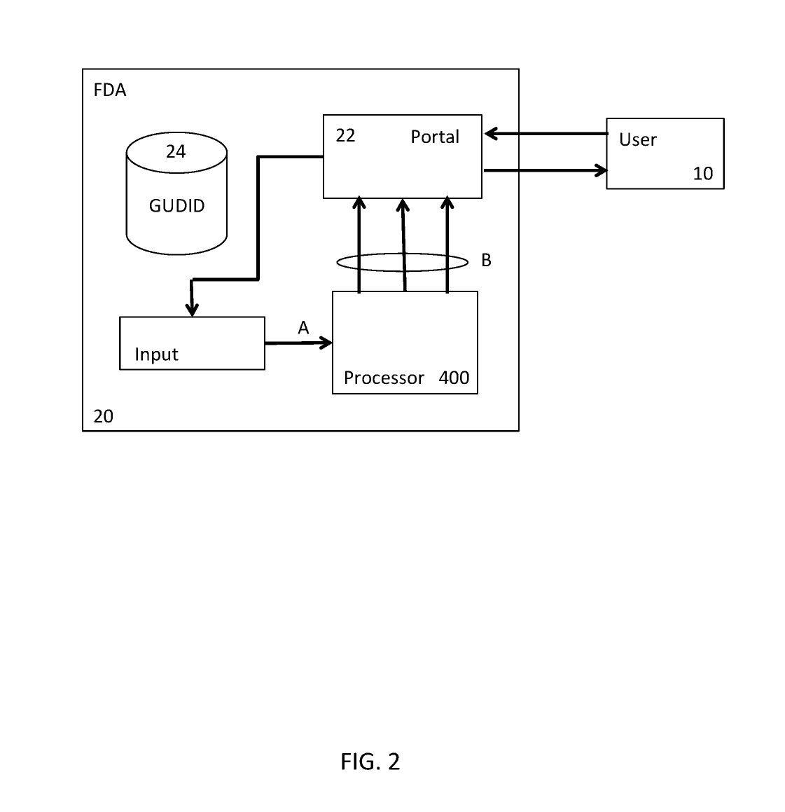

In a second embodiment (FIG. 2), the processor 400 is incorporated into the FDA website 20.

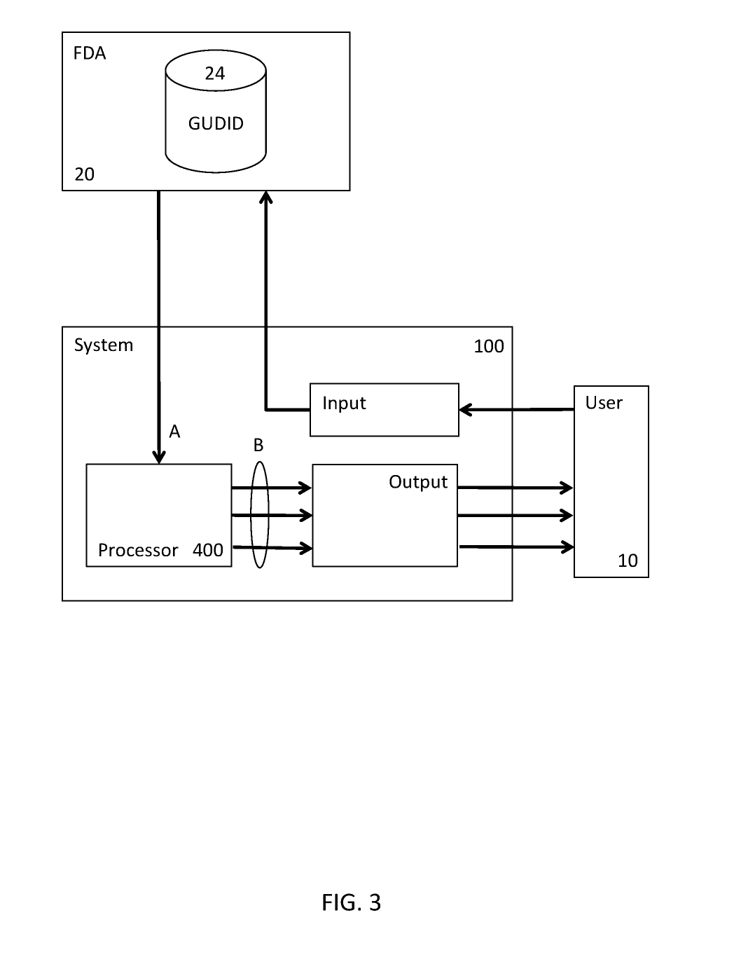

In a third embodiment (FIG. 3), the user 10 accesses the system 100 directly. Information from the GUDID database 24 may be returned to the user 10 along with the web link.

FIG. 4 is a flowchart of the process executed by the processor 400. A code source (402), such as the user 10, enters (404) the product identifier code and a determination is made whether the product identifier is valid (406). For example, does the identifier contain the correct number of characters? If not, the product identifier is rejected and a message to that effect is returned to the code source. If the product identifier is valid, it is parsed to obtain the serial number (408), the product application code (410), and the labeler code (412). A check is made to verify that the serial number matches the product application code (414). If not, the product identifier is rejected and a message to that effect is returned to the code source. If so, the serial number, the product application code, and the labeler code are output, along with a link to the product page on the manufacturer's website (416). The output may also, or instead, include a written description of the manufacturer and the product as well as any information pertaining to the specific unit, such as defects or recalls.

An example of a product for which an identifier may be generated is a connecting cable that connects two devices, such as a sensor and a pressure monitor. The cable may be identified by a combination of various types of information, including:

A1) A description/identification of the first device D1 and the second device D2; or

A2) A description/identification of the first device D1 and a range of second devices D2-Dn;

B) An application description for the connecting cable where the description is generated from device information that identify the manufacturer and model of the device, such as;

“Connecting Cable connects First Device (D1) to Second Device (D2), or to Second through nth Device (D2 to Dn)”.;

C) The serial number for the connecting cable;

D) The length of the cable;

E) Any special labeling for the cable; and

F) A default labeling for the cable.

To provide a description for an unlabeled Connecting Cable that is known to connect a first device (D1) identified by a UDI device identifier (DI-1) to a second device (D2) also identified by a UDI Device Identifier (DI-2), a trusted data base, such as GUDID, is accessed to find the manufacturer and model for the two devices and to confirm that the UDIs are valid for the information taken from the physical devices that are connected by the connecting cable.

An application code for an existing unlabeled connecting cable may be constructed from pre-assigned device codes that define the manufacturer and model for the connected devices as described in B) above.

Cooperating manufactures (labelers) are entities that cooperate in providing information to authorized users for purposes of enabling streamlined processes for identifying manufacturers and models from other data such as application codes, descriptions, and serial numbers.

Since there are a relatively small number of manufactures, it is possible to determine with reasonable certainty the manufacturer of a specific unit, provided the manufacturer cooperates. Generally it is assumed that manufacturers will cooperate.

For the UDI system to be effective in resolving problems related to the product unit, a product history must be maintained for the time since the UDI was assigned and the time that the problem occurred. The product history should provide sufficient detail to identify events that may have damaged the product during the time between UDI assignment and occurrence of a problem. It is also important that the product unit be controlled while the cause of the problem is being investigated.

One objective of the present invention is to provide a system for streamlining access to product information that takes advantage of a serial number or equivalent identifier labeled on the product itself in the case of Connecting Cables or on a separate controlled document for a unit such as a contact lens.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for providing access to information about a product, comprising:
receiving from a user an identifier identifying a single unit of a product , the identifier comprising a serial number of the unit, a labeler code identifying a manufacturer of the unit, and a product application code identifying a specific application for the unit;
determining if the identifier is a valid identifier;
if the identifier is invalid, rejecting the identifier and sending an error message to the user;
if the identifier is valid:
parsing the identifier into a serial number, a product application code, and a labeler code;
determining if the serial number matches the product application code;
if the serial number does not match the product application code, rejecting the identifier and sending an error message to the user;
if the serial number matches the product application code, sending to the user access to information identifying the manufacturer of the product and information pertaining to the specific unit.

2. The method of claim 1, further comprising, if the serial number matches the product application code, sending to the user a link to a page of the manufacturer's website on which information about the unit is available.

3. A system for providing access to information about a product, comprising:
an input module configured to receive from a user an identifier identifying a single unit of a device model, the identifier comprising a serial number of the unit, a labeler code identifying a manufacturer of the unit, and a product application code identifying a specific application for the unit;
a first validation module configured to determine if the identifier is a valid identifier and to reject the identifier and send an error message to the user if the identifier is not valid;
a parsing module configured to parse the identifier into a serial number, a product application code, and a labeler code;
a second validation module configured to determine if the serial number matches the product application code and to reject the identifier and send an error message to the user if the serial number does not match the product application code; and
an output module configured to provide to the user access to information identifying the manufacturer of the product and information pertaining to the specific unit.

4. The system of claim 3, wherein the output module is further configured to send to the user a link to a page of the manufacturer's website on which information about the unit is available.

5. The system of claim 3, further comprising:
a first interconnection between the input module and a U.S. Food and Drug Administration (FDA) website through which the user enters the identifier; and
a second interconnection between the output module and the FDA website through which the user receives the information.

6. The system of claim 3, wherein the system is integrated into an FDA system. SYSTEM AND METHOD FOR STREAMLINING ACCESS TO DEVICE INFORMATION
